(19) United States
(12) Patent Application Publication
(10) Pub. No.: US 2013/0082608 A1
(43) Pub. Date: Apr. 4, 2013

(54) DIMMING BALLAST AND RELATED METHOD ALLOWING INDIVIDUAL CONTROL OF MULTIPLE LAMPS

(71) Applicant: Jaiganesh Balasubramanian, Beaverton, OR (US)

(72) Inventor: Jaiganesh Balasubramanian, Beaverton, OR (US)

(73) Assignee: Leviton Manufacturing Co., Inc., Melville, NY (US)

(21) Appl. No.: 13/248,739

(22) Filed: Sep. 29, 2011

(51) Int. Cl. H05B 37/02; H05B 35/00

(52) U.S. Cl. 315/178; 315/297

(57) ABSTRACT

A dimming ballast allowing individual control of multiple lamps is described. The ballast includes a lamp driver to control at least one lamp. Further, the ballast includes a current sensing module , connected as part of a feedback loop from the at least one lamp to the lamp driver, the current sensing module being configured with a maximum allowable output current value for each lamp. A lamp resonant circuit, connected between the lamp driver and the at least one lamp, operates over the entire range of the output current values. A lamp status module is coupled to the lamp driver for monitoring at least one condition related to the at least one lamp being controlled. Moreover, a control module controls the lamp driver independently based on a feedback loop from the lamp status module. Various embodiments of the dimming ballast along with related methods are also described.

### TECHNICAL FIELD

This disclosure relates to lighting ballasts and, more particularly, to methods and systems for individual control of multiple lamps.

### BACKGROUND

Ballasts in intelligent lighting control systems provide flicker-free lighting and reduced energy costs in office buildings, medical offices, schools, laboratories, restaurants, government facilities and any other location that could benefit from the cost and energy savings.

Typically, ballasts for lighting include a lamp driver that controls the current in one or more lamps of the same type, and controls the output current of the lamps. The lamp driver may also control the dimming of the lamps. Lamps are organized by type or family, with some common examples including T5, T8, and T12 lamps, which are organized by wattage and shape of the lamp.

In a conventional system, a lamp driver is designed to control only a certain number of lamps; for example, a ballast having a lamp driver designed to control only one lamp is called a one-lamp ballast, a ballast having a lamp driver designed to control two lamps is called a two-lamp ballast, and so on. Further, a lamp driver is designed to operate in conjunction with only one lamp type.

It would be highly desirable to have a more flexible and configurable ballast capable of operating with a plurality of lamps which may be of different lamp types.

### SUMMARY

One embodiment of the present disclosure provides a dimming ballast allowing individual control of multiple lamps. The ballast includes a lamp driver to control at least one lamp. Further, the ballast includes a current sensing module, connected as part of a feedback loop from the at least one lamp to the lamp driver, the current sensing module being configured with a maximum allowable output current value for each lamp. A lamp resonant circuit, connected between the lamp driver and the at least one lamp, operates over the entire range of the output current values. A lamp status module is coupled to the lamp driver for monitoring at least one condition related to the at least one lamp being controlled. Moreover, a control module controls the lamp driver independently based on a feedback loop from the lamp status module.

An alternative embodiment is a method for individual control of multiple lamps through a dimming ballast. The method involves providing at least one lamp driver having at least one connected lamp and controlling the at least one connected lamp through each lamp driver. Further, the method includes setting a maximum allowable output current value for the at least one lamp connected to each lamp driver, through a current sensing module and configuring a lamp resonant circuit to operate over the entire range of output current values. The method then receives a dimmer input for at least one of the lamp drivers, controlling the output of the at least one connected lamp. Moreover, the method monitors at least one condition related to the at least one lamp and controls each lamp driver independently based on the monitored conditions.

### BRIEF DESCRIPTION OF THE DRAWINGS

FIG. 1 illustrates an embodiment of a ballast including a lamp driver controlling one lamp.

FIG. 2 illustrates an embodiment of a ballast including a lamp driver controlling two lamps.

FIG. 3 illustrates an embodiment of a ballast including a lamp driver controlling three lamps.

FIG. 4 illustrates a four-lamp ballast capable of controlling lamps that are of different lamp types.

FIG. 5 illustrates an alternate embodiment of a ballast in accordance with the present disclosure.

FIG. 6 illustrates an exemplary embodiment of a method for individual control of multiple lamps through the dimming ballast of the embodiment in FIG. 4.

FIGS. 7, 8, 9, and 10 illustrate various graphs representing the frequency response of a ballast having a fixed set of LC values, determined based on empirical analysis.

### DETAILED DESCRIPTION

The following detailed description is made with reference to the figures. Preferred embodiments are described to illustrate the disclosure, but these embodiments are not to limit its scope, which is defined by the claims. Those of ordinary skill in the art will recognize a variety of equivalent variations on the description that follows.

### Overview

According to aspects of the present disclosure illustrated here, a dimming ballast allowing individual control of multiple lamps is described. The ballast includes at least one lamp driver, where if the ballast includes two or more lamp drivers, the lamp drivers are connected in parallel. Each lamp driver controls one or more lamps connected in series. A maximum allowable output current value for each lamp is set in a current sensing module . Each lamp driver is connected to a lamp resonant circuit that operates over the entire range of output current values. Lamp status modules monitor conditions related to the lamps and a control module controls each lamp driver independently, based on a feedback loop from each lamp status module. As a result, the number and the types of lamps in the dimming ballast of the present disclosure can vary.

### Exemplary Embodiments

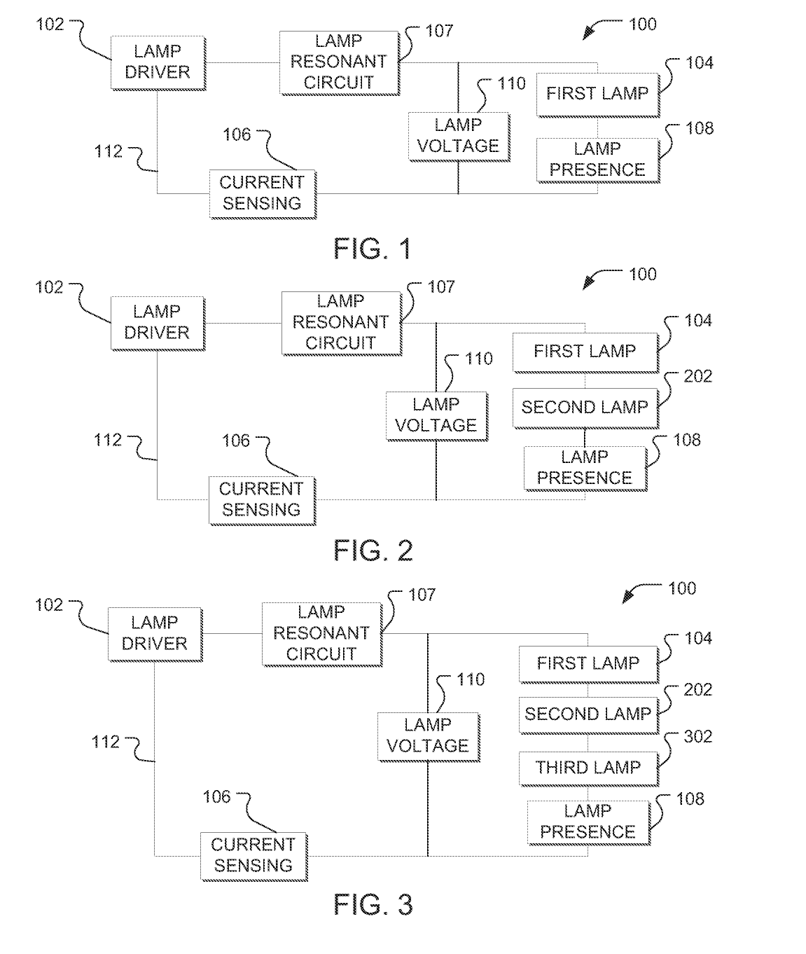

FIGS. 1, 2, and 3 illustrate an exemplary ballast 100 having a lamp driver 102 capable of controlling a varying number of lamps. FIG. 1 depicts the ballast 100 controlling first lamp 104, while in FIG. 2, the ballast 100 controls first lamp 104 and second lamp 202, where lamps 104 and 202 are connected in series. In FIG. 3, the ballast 100 controls first lamp 104, second lamp 202, and third lamp 302, where lamps 104, 202, and 302 are connected in series.

FIGS. 1, 2, and 3 also include a current sensing module 106, which senses the output current across at least one of the lamps. Based on the sensed value, the current sensing module 106 helps maintain nearly constant current across the lamps through a feedback loop 112 returning to the lamp driver 102.

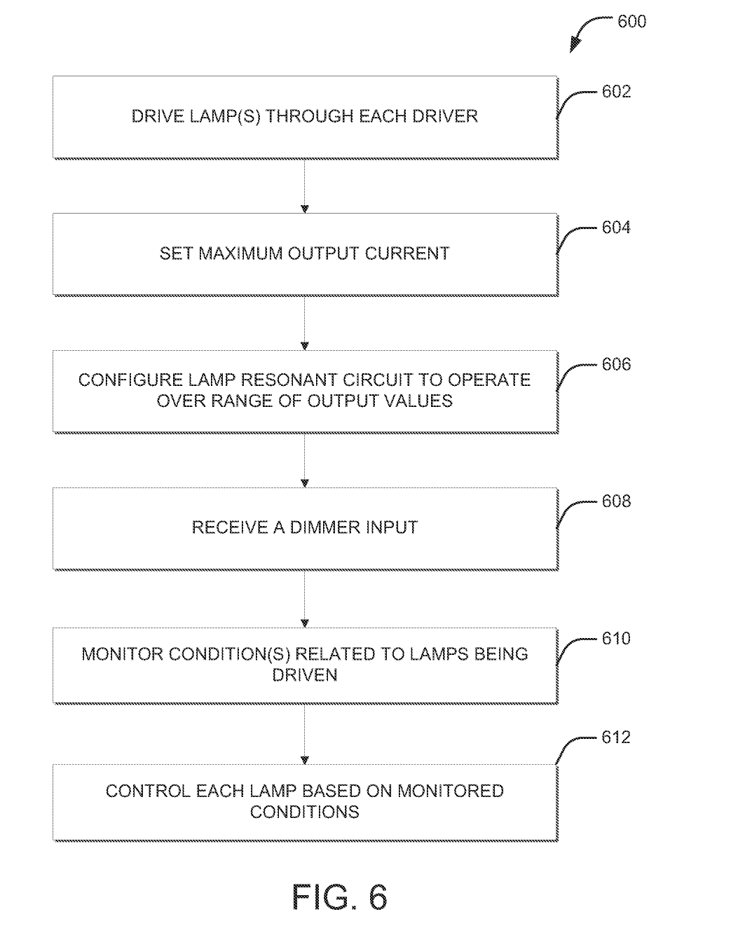

The current sensing module 106 is configured to allow a maximum current output across the lamps, and the current sensing module 106 works in conjunction with other ballast modules to ensure that the output current of the lamps does not exceed the maximum value. The functioning of this system will be explained in more detail in connection with FIG. 6.

The ballast 100 preferably also includes a lamp resonant circuit 107, which is an LC circuit, connected to the current sensing module 106. LC circuits are well understood in the art and typically include an inductor (L) and a capacitor (C). The values of the inductor and capacitor in the LC circuit are suitably configured to allow operation over the entire range of output current values. The lamp driver 102 produces a square wave at a particular switching frequency. The lamp resonant circuit 107 resonates at this frequency and provides an alternating current to the connected lamps at the same frequency.

Further, each lamp driver includes a lamp status module. Each lamp status module includes a lamp presence module 108 and a lamp voltage module 110, as shown in FIGS. 1, 2, and 3. The lamp presence module 108 is connected in series with the lamps and senses whether lamp(s) are connected in the ballast 100. The lamp voltage module 110 is connected in parallel with the lamps and measures the lamp voltage across the lamps. Other modules to sense lamp status or conditions, for example, preheat, strike, ignition, run mode, End of Life, etc., may also be included in the ballast 100.

By connecting the lamps in series and by incorporating current sensing module 106, feedback loop 112, lamp resonant circuit 107, the ballast 100 provides a flexible and configurable ballast capable of operating with a variable number of lamps and different types of lamps. In contrast, in conventional systems, a different lamp driver would be required for each of the embodiments of FIGS. 1, 2, and 3, as a conventional lamp driver is designed to drive a fixed number of lamps only. In accordance with the present disclosure however, the number of lamps being controlled by the lamp driver 102 may vary. For example, contrary to prior art lamp drivers, lamp driver 102 can power 1 lamp, 2 lamps, 3 lamps, or more.

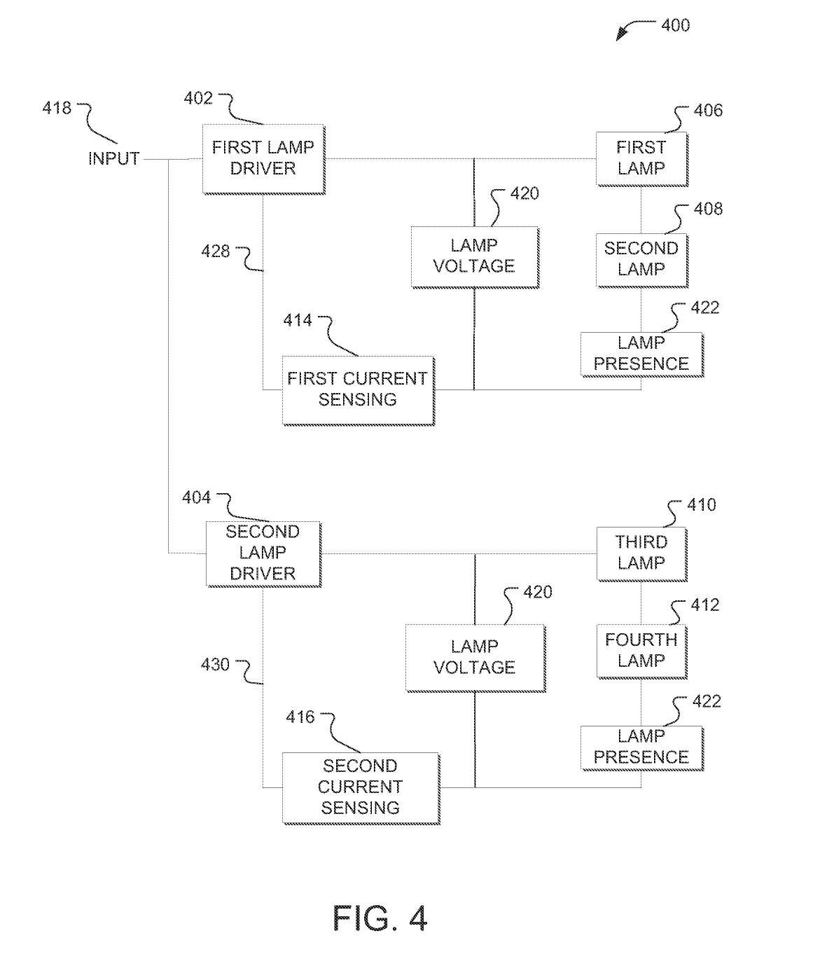

FIG. 4 illustrates an embodiment of a four-lamp ballast 400 capable of controlling a plurality of lamps, where the lamps may be of different types or families. The ballast 400 includes first lamp driver 402 and second lamp driver 404, where lamp drivers 402 and 404 are connected in parallel.

The first lamp driver 402 controls first lamp 406 and second lamp 408, where lamps 406 and 408 are connected in series. A first feedback loop 428 includes a first current sensing module 414, which feeds the lamp current back to the first lamp driver 402.

Similarly, the second lamp driver 404 controls third lamp 410 and fourth lamp 412, where lamps 410 and 412 are connected in series. A second feedback loop 430 includes a second current sensing module 416, which feeds the lamp current back to the second lamp driver 404. The current sensing modules 414 and 416 may be current transformers, but in other embodiments, the current sensing modules 414 and 416 can be, but not limited to, a shunt resistor placed in the current path, hall effect sensors, etc. It is understood by those of skill in the art that any other current sense device, now known or hereafter developed, may be utilized without departing from the scope and purpose of the claimed invention.

Using the configuration illustrated in FIG. 4, the first lamp driver 402 may control lamps of a different type or family as compared to the lamps of the second lamp driver 404. For example, the first lamp 406 and the second lamp 408 may include a lamp type different from the lamp type of the third lamp 410 and the fourth lamp 412. For example, the first lamp 406 and the second lamp 408 may be 32-watt T8 lamps, while the third lamp 410 and the fourth lamp 412 may be 14-watt T5 lamps. Further, the number of lamp drivers in the ballast 400 can vary, as can the number of lamps connected to each lamp driver.

Using the configuration illustrated in FIG. 4, the first lamp driver 402 may control lamps of a different wattage as compared to the lamps of the second lamp driver 404. For example, the first lamp 406 and the second lamp 408 may be 32-watt T8 lamps, while the third lamp 410 and the fourth lamp 412 may be 17-watt T8 lamps. Further, the number of lamp drivers in the ballast 400 can vary, as can the number of lamps connected to each lamp driver.

The first current sensing module 414 and the second current sensing module 416 each sense the current of the corresponding lamps (the first lamp 406 and the second lamp 408, and the third lamp 410 and the fourth lamp 412, respectively) and in turn control the output current through the feedback loops 428 and 430 to their respective lamp driver 402 and 404, respectively. The current sensing modules 414 and 416 each are configured to limit the output current at the lamps to a maximum output current value.

Each current sensing module 414 and 416 is preferably connected to a corresponding lamp resonant circuit (not shown), which is preferably an LC circuit. The values of the inductor and capacitor in each LC circuit are preferably configured to allow operation over the entire range of output current values. Because of this configuration, nearly constant output current can be maintained from the lamps, which facilitates varying the lamp type and the number of lamps supported by the ballast.

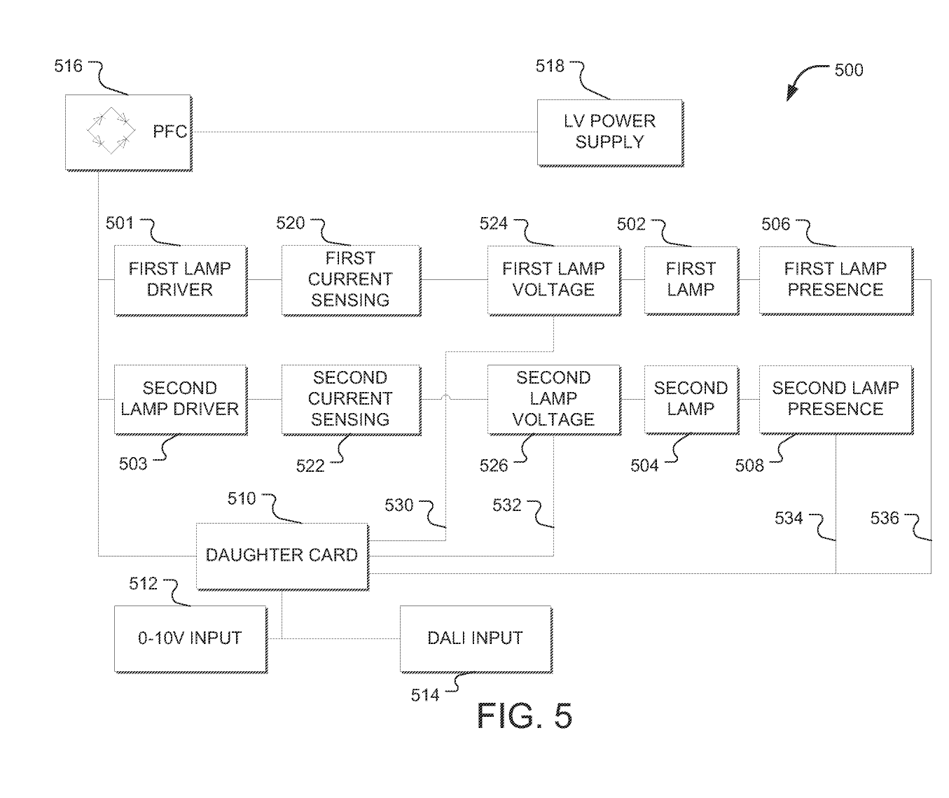

An input module 418 provides input current to both the first lamp driver 402 and the second lamp driver 404. The input module 418 can also help control the dimming of the lamps. This module will be described in more detail below in connection with FIG. 5.

Similar to the ballast 100 of FIG. 1, each lamp driver (402 and 404) in the ballast 400 includes a lamp status module. Each lamp status module includes a lamp voltage module 420 and a lamp presence module 422, as shown in FIG. 4. The lamp presence module 422 is connected in series with the lamps and senses whether lamp(s) are connected in the ballast 400. The lamp voltage module 420 is connected in parallel with the lamps and measures the lamp voltage across the lamps. Other modules to sense lamp status or conditions, for example, preheat, strike, ignition, run mode, End of Life, etc., may also be included in the ballast 400.

FIG. 5 depicts an exemplary embodiment of a ballast 500 in accordance with the present disclosure. Similar to the ballast 400 of FIG. 4, the ballast 500 has two lamp drivers. A first lamp driver 501, a first current sensing module 520, a first lamp voltage module 524, a first lamp 502, and a first lamp presence module 506 are connected in series in the recited order, as shown in FIG. 5. In the same manner, a second lamp driver 503, a second current sensing module 522, a second lamp voltage module 526, a second lamp 504, and a second lamp presence module 508 are connected in series in the recited order, as shown in FIG. 5. As explained earlier in connection with FIG. 4, lamp presence module and lamp voltage module form a lamp status module, which may further include modules to sense lamp status or conditions, for example, preheat, strike, ignition, run mode, End of Life, etc.

The first lamp voltage module 524, the first lamp presence module 506, the second lamp voltage module 526, and the second lamp presence module 508 monitor and communicate this information to a control module, such as a daughter card 510. As depicted in FIG. 5, the first lamp voltage module 524, the first lamp presence module 506, the second lamp voltage module 526, and the second lamp presence module 508 are connected to the daughter card 510 through first feedback loop 530, second feedback loop 532, third feedback loop 534, and fourth feedback loop 536, respectively.

The daughter card 510 preferably includes a microprocessor that controls the various lamps in the ballast 500. The daughter card 510 preferably can send an on/off signal to the lamps and can perform other functions including interfacing with the lamp status modules. The daughter card 510 may process the monitored lamp status or conditions, such as lamp voltage, lamp presence, lamp condition (preheat, strike, ignition, run mode, End of Life, and so on) and control the lamp drivers 501 and 503 accordingly.

The daughter card 510 may receive inputs from a 0-10V circuit 512 and a Digital Addressable Lighting Interface (DALI) input circuit 514, although in other implementations, this input circuit 514 may utilize any applicable protocol known in the art. The 0-10V circuit 512 can provide input voltage varying between 0 to 10 Volts. As this voltage changes, the lamps in the ballast 500 will dim accordingly. The DALI input circuit 514 allows control of the lamps through a digital line, in accordance with the DALI protocol which is well understood in the art.

The ballast 500 also preferably includes a Power Factor Correction (PFC) module 516 for converting AC voltage to DC, which is fed into both lamp drivers 501 and 503, and in turn, to the connected lamps—first lamp 502 and second lamp 504. The PFC 516 preferably also powers a low voltage power supply 518 which supplies power to all auxiliary circuits in the ballast 500 including the 0-10V circuit 512 and the DALI input circuit 514.

FIG. 6 shows an exemplary embodiment of a method 600 for providing individual control of multiple lamps through the ballast 400 of the embodiment illustrated in FIG. 4. At step 602, the first lamp 406 and the second lamp 408 are controlled via the first lamp driver 402, while the third lamp 410 and the fourth lamp 412 are controlled via the second lamp driver 404.

At step 604, a maximum output current for the lamps corresponding to each of the lamp drivers 402 and 404 is set through the first current sensing module 414 and the second current sensing module 416, respectively. The maximum output current is set by changing resistor values in the current sensing modules 414 and 416.

The lamp resonant circuit is configured at step 606 to operate over the entire range of lamp output current values, as already discussed in relation to the embodiment of FIG. 4. The lamp resonant circuit includes an inductor and a capacitor, the values of which are preferably configured based on worst-case scenario simulations. During these simulations, circuit operation region can be observed for different ranges of switching frequency, peak output current, etc. Based on the predetermined maximum output current and other known circuit specification, the values of the inductor and capacitor in the resonant circuit are determined. This process is well known in the art.

At step 608, a dimmer input through, for instance, the 0-10V circuit 512 is received for one or more of the lamp drivers 402 and 404 (see FIG. 4). Thus, the output of the lamps 406 and 408 can be controlled independently of the output of the lamps 410 and 412.

One or more conditions related to the lamps 406, 408, 410, and 412 (depicted in FIG. 4) are monitored at step 610. For example, the first current sense module 414 monitors the constant current in the filament of third lamp 410, which is fed back into the first lamp driver 402. The first current sense module 414 may monitor the output current through one of the first lamp 406 and second lamp 408, since the lamps 406 and 408 are connected in series. Similar monitoring may be performed by the second current sensing module 416. Other conditions that may be monitored include without limitation lamp voltage, presence of one or more lamps, End of Life (EOL), Lamp Operation Mode (such as strike, preheat, ignition, running, and so on), etc.

At step 612, each lamp in the ballast 400 is driven independently based on the monitored conditions. Based on the monitored output current, the current across the first lamp 406 and second lamp 408 is kept constant by the first lamp driver 402. Even if the number or type of lamps connected to the first lamp driver 402 changes, the lamp output current would remain constant as the first lamp driver 402 automatically adjusts the input voltage to meet the required output current.

It will be known to those skilled in the art that each lamp has a specification for operating current and voltage. Therefore, if the lamp output current is fixed, the associated lamp driver automatically adjusts the input switching frequency so that the specific current and voltage characteristics across the lamp are maintained.

Although the method 600 has been described as operating in the ballast 400 of FIG. 4, it may operate within any ballast in accordance with the present disclosure.

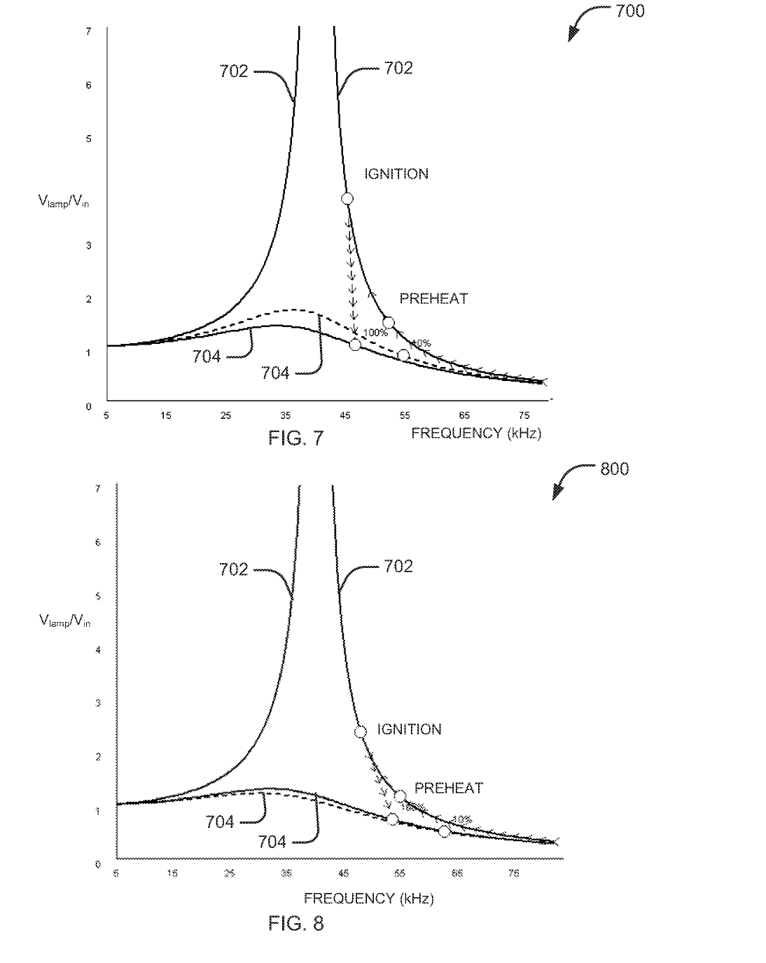

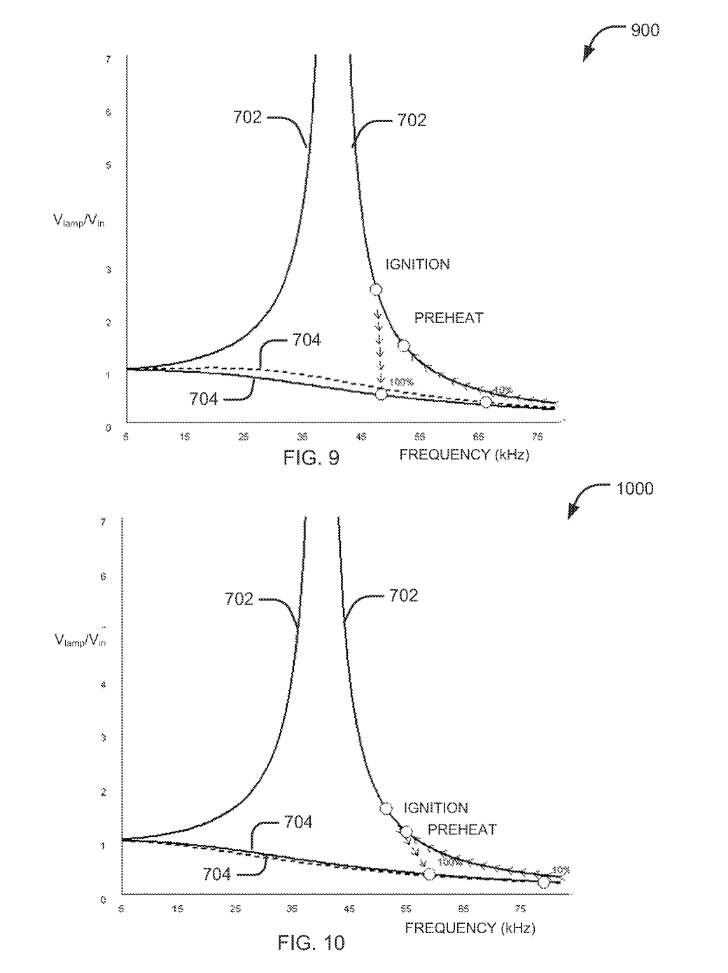

FIGS. 7, 8, 9, and 10 depict graphs 700, 800, 900, and 1000 respectively, representing the frequency response of the ballast 100 having a fixed set of LC values, determined based on empirical analysis. The FIGS. 7, 8, 9, and 10 plot Vₗₐₘₚ and Vᵢₙ against frequency, where Vₗₐₘₚ is the lamp voltage and Vᵢₙ is the input voltage. Graph 700 is based on a driver operating 2 lamps of 32 Watt each; Graph 800 is based on the driver operating 2 lamps of 17 Watt each; Graph 900 is based on the driver operating one 32 Watt lamp; and Graph 1000 is based on the driver operating one 17 Watt lamp. All the lamps are of the same type.

FIGS. 7, 8, 9, and 10 depict how an optimized inductor and capacitor (LC) circuit can be used over different ranges of voltages and number of lamps, while maintaining higher frequency during preheat and lower frequency during ignition and 100% operation.

Lines 702 represent the plots for Vₗₐₘₚ while lines 704 represent the plots for Vᵢₙ. Generally in lamp circuits, the preheat frequency is high and the current is low. The ignition frequency is typically slightly lower than the run frequency, which is labeled as 100%. Further, all these frequencies may be required to be above a threshold. For example, the threshold could be 42 KHz to ensure that the frequency does not enter the infrared region. FIGS. 7, 8, 9, and 10 show that such criteria are satisfied by the optimized LC circuit even as the number and wattage of the lamps is varied. Similarly, the LC circuits connected to different drivers in the same ballast may be optimized individually to facilitate variation of lamp number and type from one driver to the other.

The terminology used herein is for the purpose of describing particular embodiments only and is not intended to be limiting of the disclosure. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A dimming ballast allowing individual control of multiple lamps, the ballast comprising:
a lamp driver configured to control at least one lamp;
a current sensing module connected as part of a feedback loop from the at least one lamp to the lamp driver, the current sensing module configured with a maximum allowable output current value for each lamp;
a lamp resonant circuit, connected between the lamp driver and the at least one lamp, configured to operate over the entire range of the output current values;
a lamp status module coupled to the lamp driver, the lamp status module being configured to monitor at least one condition related to the at least one lamp being controlled; and
a control module configured to control the lamp driver independently based on a feedback loop from the lamp status module.

2. The ballast of claim 1, wherein the ballast includes at least two lamp drivers connected in parallel.

3. The ballast of claim 2, wherein the type of the at least one lamp corresponding to one lamp driver are different from the type of the at least one lamp corresponding to at least one of the other lamp drivers.

4. The ballast of claim 2, wherein the control module has an input configured to trigger dimming through the lamp driver.

5. The ballast of claim 1 further comprising a power supply configured to power the ballast.

6. The ballast of claim 1, wherein the control module is configured to regulate current through each lamp.

7. The ballast of claim 1 wherein the control module is configured to maintain nearly constant current through each lamp being controlled by the lamp driver.

8. The ballast of claim 1 wherein at least one of the conditions is lamp voltage.

9. The ballast of claim 1 wherein at least one of the conditions is whether at least one of the lamps is coupled to at least one of the lamp drivers.

10. The ballast of claim 1 further comprising a power factor correction module positioned at the front end of the ballast.

11. The ballast of claim 1 wherein the lamp status module includes a lamp voltage module and a lamp presence module.

12. The ballast of claim 11, wherein the lamp presence module is connected in series with the at least one lamp and the lamp voltage module is connected in parallel with the at least one lamp, the lamp presence module being configured to sense whether the at least one lamp is connected, the lamp voltage module being configured to measure the lamp voltage across the at least one lamp.

13. The ballast of claim 11, wherein the control module is configured to maintain nearly constant current through each lamp being controlled by the lamp driver for a particular family of lamps and the lamp voltage module is connected in parallel with the at least one lamp, the feedback loop from the lamp voltage signal being configured to detect what type of lamp has been connected thereto.

14. The ballast of claim 11, wherein the control module is configured to maintain nearly constant current through each lamp being controlled by the lamp driver for a particular family of lamps and the lamp voltage module is connected in parallel with the at least one lamp, the feedback from the lamp voltage signal being configured to detect the number of lamps been connected thereto.

15. A method for individual control of multiple lamps through a dimming ballast, the method comprising:
providing at least one lamp driver having at least one connected lamp;
controlling the at least one connected lamp through each lamp driver;
setting a maximum allowable output current value for the at least one lamp connected to each lamp driver, through a current sensing module ;
configuring a lamp resonant circuit to operate over the entire range of output current values;
receiving a dimmer input for at least one of the lamp drivers, controlling the output of the at least one connected lamp;
monitoring at least one condition related to the at least one lamp; and
controlling each lamp driver independently based on the monitored conditions.

16. The method of claim 15, wherein controlling each lamp driver independently based on the monitored conditions further comprises regulating the current through each lamp.

17. The method of claim 15, wherein controlling each lamp driver independently based on the monitored conditions further comprises maintaining nearly constant current through each lamp connected to a lamp driver.

18. The method of claim 15, wherein at least one of the conditions is lamp voltage.

19. The method of claim 15, wherein at least one of the conditions is whether at least one of the lamps is coupled to at least one of the lamp drivers.

20. The method of claim 15 further comprising correcting a power factor at the front end of the ballast.

21. The method of claim 15 further comprising connecting at least two lamp drivers in parallel.

22. The method of claim 21, wherein the type of the at least one lamp corresponding to one lamp driver are different from the type of the at least one lamp corresponding to at least one of the other lamp drivers.
